(19) United States
(12) Patent Application Publication
(10) Pub. No.: US 2015/0017969 A1
(43) Pub. Date: Jan. 15, 2015

(54) IN-VEHICLE COMMUNICATION SYSTEM, IN-VEHICLE COMMUNICATION APPARATUS, AND MOBILE COMMUNICATION TERMINAL

(71) Applicant: DENSO CORPORATION, Kariya-city, Aichi-pref (JP)

(72) Inventor: Masaya Takatsuji, Kariya-city (JP)

(21) Appl. No.: 14/377,192

(22) PCT Filed: Apr. 10, 2013
(86) PCT No.: PCT/JP2013/002432

§ 371 Date: Aug. 7, 2014

(30) Foreign Application Priority Data
Apr. 11, 2012 (JP) 2012-90115

(51) Int. Cl. H04W 48/04; H04W 4/04; H04M 1/60

(52) U.S. Cl. CPC H04W 48/04; H04M 1/6075; H04W 4/046
USPC 455/418

(57) ABSTRACT

An in-vehicle communication system includes: an in-vehicle communication apparatus equipped to a vehicle; a first mobile communication terminal connected in a communicable manner with the in-vehicle communication apparatus; and a second mobile communication terminal connected in a communicable manner with the first mobile communication terminal. The in-vehicle communication apparatus, the first mobile communication terminal, and the second mobile communication terminal each has a cooperative application program for executing multiple contents cooperatively with one another. The first mobile communication terminal forbids operational input and/or screen output of a predetermined content. When a travel determination unit determines that the vehicle is running, the in-vehicle communication apparatus forbids operational input and/or screen output with respect to the predetermined content. The second mobile communication terminal enables operational input and/or screen output with respect to the predetermined content.

### CROSS REFERENCE TO RELATED APPLICATION

The present disclosure is based on Japanese Patent Application No. 2012-090115 filed on Apr. 11, 2012, the description of which is incorporated herein.

### TECHNICAL FIELD

The present disclosure relates to an in-vehicle communication system including an in-vehicle communication apparatus equipped to a vehicle and a mobile communication terminal connected in a communicable manner with the in-vehicle communication apparatus, and also relates to an in-vehicle communication apparatus and a mobile communication terminal which configure the in-vehicle communication system.

### BACKGROUND ART

Conventionally, an in-vehicle communication system which automatically connects the following in a communicable manner with each other has been devised as disclosed in, for example, Patent Document 1: an in-vehicle communication apparatus equipped to a vehicle and a mobile communication terminal carried into the vehicle compartment of the vehicle.

With respect to this type of system, a technology for cooperatively executing contents by an in-vehicle communication apparatus and a mobile communication terminal has been devised. Further, in relation to this cooperation technology, a configuration for carrying out, for example, the following has been devised to prevent a driver from manipulating a mobile communication terminal during vehicle running: the utilization of contents from the mobile communication terminal is forbidden and the contents are utilized from an in-vehicle communication apparatus. In addition, with respect to some contents considered undesirable to utilize during vehicle running, a configuration for carrying out the following has been devised: the utilization of the contents from an in-vehicle communication apparatus is also forbidden. However, with these configurations, not only the driver of a vehicle but also users other than the driver cannot utilize contents. That is, users considered not to affect a driving safety even if they utilize the contents during vehicle running cannot utilize the contents, either.

### PRIOR ART DOCUMENT

### Patent Document

Patent Document 1: JP 2011-223511 A

### SUMMARY OF INVENTION

In view of the foregoing difficulties, it is an object of the present disclosure to provide an in-vehicle communication system that provides a content which is available to a user even during a vehicle running under a condition that a driving safety is not affected by the user even if the user utilizes a content during the vehicle running, and an in-vehicle communication apparatus and a mobile communication terminal utilized in the in-vehicle communication system.

According to an aspect of the present disclosure, an in-vehicle communication system includes an in-vehicle communication apparatus equipped to a vehicle, a first mobile communication terminal, and a second mobile communication terminal. The first mobile communication terminal is connected in a communicable manner with the in-vehicle communication apparatus. The second mobile communication terminal is connected in a communicable manner with the first mobile communication terminal. Each of the in-vehicle communication apparatus, the first mobile communication terminal, and the second mobile communication terminal has a cooperative application program for executing a plurality of contents cooperatively with one another. Each of the plurality of contents includes an application program and a plurality of data required for providing a user with functions corresponding to the content. The first mobile communication terminal includes a content execution unit, a transmission unit, and a terminal-side forbidding unit. The content execution unit executes an application program of a predetermined content to process a plurality of data of the predetermined content based on an external operation. The predetermined content is one of the plurality of contents. The transmission unit transmits an execution result of the application program of the predetermined content to at least one of the in-vehicle communication apparatus or the second mobile communication terminal. The terminal-side forbidding unit, when connected in a communicable manner with the in-vehicle communication apparatus, forbids an operational input with respect to the predetermined content on the first mobile communication terminal and a screen output of the predetermined content on the first mobile communication terminal. The in-vehicle communication apparatus includes a travel determination unit and an apparatus-side forbidding unit. The travel determination unit determines whether or not the vehicle is running. The apparatus-side forbidding unit, when the travel determination unit determines that the vehicle is running, forbids at least one of an operational input with respect to the predetermined content on the in-vehicle communication apparatus or a screen output of the predetermined content on the in-vehicle communication apparatus. The second mobile communication terminal includes a providing unit that enables at least one of an operational input with respect to the predetermined content on the second mobile communication terminal or a screen output of the predetermined content on the second mobile communication terminal.

With the above in-vehicle communication system, a user, who is considered not to affect a driving safety even if the user utilizes contents during vehicle running, can utilize the contents during vehicle running.

According to another aspect of the present disclosure, an in-vehicle communication apparatus to which a mobile communication terminal is connected in a communicable manner includes a travel determination unit and an apparatus-side forbidding unit. The in-vehicle communication apparatus is equipped to a vehicle and has a cooperative application program for executing a plurality of contents cooperatively with the mobile communication terminal. The travel determination unit determines whether or not the vehicle is running. The apparatus-side forbidding unit, when the travel determination unit determines that the vehicle is running, forbids at least one of an operational input with respect to a predetermined content on the in-vehicle communication apparatus or a screen output of the predetermined content on the in-vehicle communication apparatus. The predetermined content is one of the plurality of contents.

With the above in-vehicle communication apparatus, a user, who is considered not to affect a driving safety even if the user utilizes contents during vehicle running, can utilize the contents during vehicle running.

According to another aspect of the present disclosure, a mobile communication terminal, when a different mobile communication terminal is not connected in a communicable manner with an in-vehicle communication apparatus equipped to a vehicle, is connected in a communicable manner with the in-vehicle communication apparatus as a main mobile communication terminal and includes a content execution unit, a transmission unit, and a terminal-side forbidding unit. The mobile communication terminal has a cooperative application program for executing a plurality of contents cooperatively with the in-vehicle communication apparatus. Each of the plurality of contents includes an application program and a plurality of data required for providing a user with functions corresponding to the content. The content execution unit executes an application program of a predetermined content to process a plurality of data of the predetermined content based on an external operation. The predetermined content is one of the plurality of contents. The transmission unit, when the different mobile communication terminal is connected as a sub mobile communication terminal in a communicable manner with the main mobile communication terminal, transmits an execution result of the application program of the predetermined content to at least one of the in-vehicle communication apparatus or the sub mobile communication terminal. The terminal-side forbidding unit forbids an operational input with respect to the predetermined content on the main mobile communication terminal and forbids a screen output of the predetermined content on the main mobile communication terminal.

With the above mobile terminal, a user, for example, the driver, who is considered to affect a driving safety if the user utilizes contents during vehicle running, is forbidden to utilize the contents during vehicle running.

According to another aspect of the present disclosure, a mobile communication terminal, when a different mobile communication terminal is connected in a communicable manner with an in-vehicle communication apparatus equipped to a vehicle as a main mobile communication terminal, is connected in a communicable manner with the main mobile communication terminal as a sub mobile communication terminal, and includes a providing unit. The mobile communication terminal has a cooperative application program for executing a plurality of contents cooperatively with the in-vehicle communication apparatus. Each of the plurality of contents includes an application program and a plurality of data required for providing a user with functions corresponding to the content. The providing unit enables at least one of an operational input with respect to a predetermined content on the sub mobile communication terminal or a screen output of the predetermined content on the sub mobile communication terminal. The predetermined content is one of the plurality of contents. The in-vehicle communication apparatus forbids at least one of the operational input with respect to the predetermined content on the in-vehicle communication apparatus or the screen output of the predetermined content on the in-vehicle communication apparatus.

With the above mobile terminal, a user, who is considered not to affect a driving safety even if the user utilizes contents during vehicle running, can utilize the contents during vehicle running.

### BRIEF DESCRIPTION OF DRAWINGS

The above and other objects, features and advantages of the present disclosure will become more apparent from the following detailed description made with reference to the accompanying drawings. In the drawings:

FIG. 1 is a drawing schematically illustrating an overall configuration including an in-vehicle communication system according to an embodiment;

FIG. 2 is a drawing schematically illustrating a configuration of an in-vehicle communication apparatus and mobile communication terminals included in an in-vehicle communication system;

FIG. 3 is a drawing schematically illustrating how an in-vehicle communication apparatus and a main mobile communication terminal execute a predetermined content cooperatively with each other when the vehicle is not running;

FIG. 4 is a drawing schematically illustrating how an in-vehicle communication apparatus and a main mobile communication terminal execute a predetermined content cooperatively with one another when the vehicle is running;

FIG. 5 is a drawing schematically illustrating how an in-vehicle communication apparatus, a main mobile communication terminal, and a sub mobile communication terminal execute a predetermined content cooperatively with one another when an in-vehicle communication system is configured;

FIG. 6 is a flowchart illustrating an example of control processing executed by an in-vehicle communication apparatus;

FIG. 7 is a flowchart illustrating an example of control processing executed by a main mobile communication terminal;

FIG. 8 is a flowchart illustrating an example of control processing executed by a sub mobile communication terminal;

FIG. 9(a) to FIG. 9(c) are drawings illustrating an example of the transition of a screen until when an in-vehicle communication apparatus and a main mobile communication terminal are connected in a communicable manner to each other and a cooperative application program is started;

FIG. 10(a) to FIG. 10(c) are drawings illustrating an example of the transition of a screen until when a cooperative application program is started with an in-vehicle communication apparatus and a main mobile communication terminal and the execution result of a predetermined content is outputted;

FIG. 11(a) to FIG. 11(c) are drawings illustrating an example of the transition of a screen observed when a cooperative application program has been started with a sub mobile communication terminal from before the vehicle starts running; and

FIG. 12(a) to FIG. 12(d) are drawings illustrating an example of the transition of a screen observed when a cooperative application program is started with a sub mobile communication terminal after the vehicle starts running.

### EMBODIMENTS FOR CARRYING OUT INVENTION

The following will describe an embodiment of the present invention with reference to the drawings.

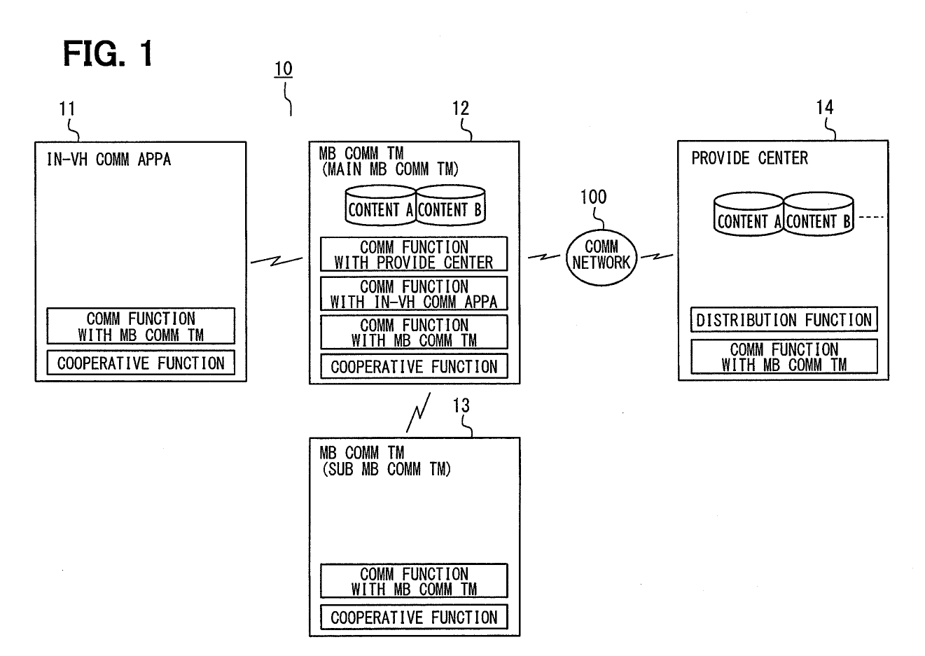

As illustrated in FIG. 1, an in-vehicle communication system 10 is configured with an in-vehicle communication apparatus 11 and multiple mobile communication terminals 12, 13. The in-vehicle communication apparatus 11 is formed as, for example, a car navigation system equipped to a vehicle. The mobile communication terminal 12 is, for example, a mobile communication terminal in possession of a vehicle driver. The mobile communication terminal 12 is carried into the vehicle compartment when any other mobile communication terminal is not connected in a communicable manner to the in-vehicle communication apparatus 11. It is then connected as main mobile communication terminal in a communicable manner to the in-vehicle communication apparatus 11. The mobile communication terminal 13 is, for example, a mobile communication terminal in possession of a user other than the vehicle driver. After the driver's mobile communication terminal is connected as main mobile communication terminal in a communicable manner to the in-vehicle communication apparatus 11, the mobile communication terminal 13 is connected as follows: it is connected as sub mobile communication terminal in a communicable manner to the main mobile communication terminal. That is, in the in-vehicle communication system 10, mobile communication terminals are set as follows: the mobile communication terminal connected first in a communicable manner to the in-vehicle communication apparatus 11 is set as main mobile communication terminal; and the mobile communication terminal connected thereafter in a communicable manner to the main mobile communication terminal is set as sub mobile communication terminal. The main mobile communication terminal corresponds to a first mobile communication terminal and the sub mobile communication terminal corresponds to a second mobile communication terminal.

When the mobile communication terminal 12 is connected as the main mobile communication terminal in a communicable manner, the in-vehicle communication apparatus 11 sends a signal representing the fact that the mobile communication terminal 12 is connected with the in-vehicle communication apparatus 11 as the main mobile communication terminal as a main in-connection signal to the different mobile communication terminal. The mobile communication terminal, which is other than the main mobile communication terminal and has received the main in-connection signal, recognizes that the main mobile communication terminal is connected to the in-vehicle communication apparatus 11. Further, the mobile communication terminal, which is other than the main mobile communication terminal and has received the main in-connection signal, is connected in a communicable manner to the main mobile communication terminal (mobile communication terminal 12), but not to the in-vehicle communication apparatus 11. Hereafter, the mobile communication terminal 12 connected in a communicable manner to the in-vehicle communication apparatus 11 will be referred to as a main mobile communication terminal 12; and the mobile communication terminal 13 connected in a communicable manner to the main mobile communication terminal 12 will be referred to as a sub mobile communication terminal 13.

The main mobile communication terminal 12 is connected to an external provide center 14 through a communication network 100 and is thereby acquires various contents distributed from the provide center 14. The provide center 14 stores various contents and distributes, through the communication network 100, contents requested by external terminals or external equipment. The various contents include: content A that provides internet radio, content B that provides facility search service, contents that provide music distribution service, contents that provide reservation service, and the like. The contents distributed from the provide center 14 include application programs and multiple data required for providing users with functions corresponding to the contents. When connected to the provide center 14 through the main mobile communication terminal 12 and the communication network 100, the sub mobile communication terminal 13 is capable of acquiring the following: various contents (application programs and data) distributed from the provide center 14.

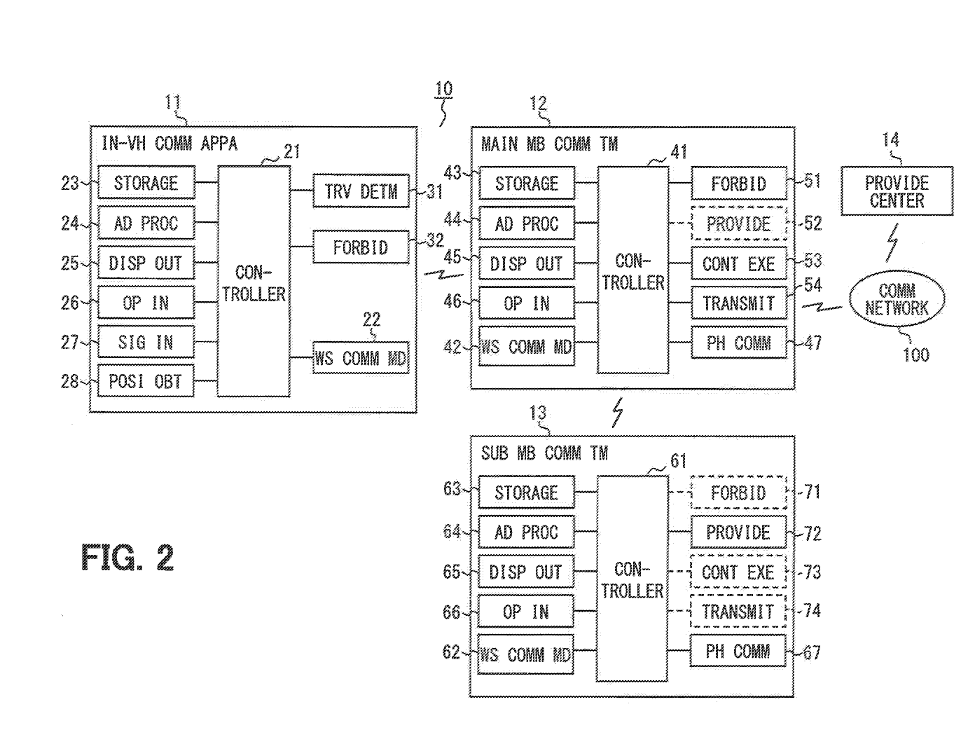

A description will be given to the configuration of the in-vehicle communication apparatus 11, the main mobile communication terminal 12, and the sub mobile communication terminal 13 with reference to FIG. 2. The main mobile communication terminal 12 and the sub mobile communication terminal 13 are identical with each other in configuration; however, in the following description, these terminals will be marked with different reference numerals for convenience of explanation.

The in-vehicle communication apparatus (IN-VH COMM APPA) 11 includes: a controller 21, a wireless communication module (WS COMM MOD) 22, a storage unit (STORAGE) 23, an audio processing unit (AD PROC) 24, a display output unit (DISP OUT) 25, an operational input unit (OP IN) 26, a signal input unit (SIG IN) 27, a position obtaining unit (POSI OBT) 28, and the like. The controller 21 is provided by a publicly known microcomputer having CPU, RAM, ROM, I/O bus, and the like, none of which is shown in the drawing. The controller 21 controls the entire operation of the in-vehicle communication apparatus 11 according to a computer program stored in ROM, the storage unit 23, or the like. The controller 21 executes a computer program and thereby virtually provides a travel determination unit (TRV DETM) 31 and an apparatus-side forbidding unit (FORBID) 32 by software.

The wireless communication module 22 establishes a radio communication line between it and the wireless communication module 42 included in the main mobile communication terminal 12. The wireless communication module 22 then carries out various communications with the main mobile communication terminal 12 through the radio communication line. The storage unit 23 is provided by a nonvolatile storage medium such as, for example, a hard disk drive. The storage unit 23 stores various programs, including various computer programs and the application programs of contents, a cooperative application program for carrying out cooperative functions to execute contents cooperatively with the external equipment or the external terminals, and data and the like used in each program.

The audio processing unit 24 is connected to a microphone and a speaker neither of which is shown in the drawing and has publicly known sound input function and sound output function. The audio processing unit 24 outputs an instruction for the operation of the in-vehicle communication apparatus 11 to the controller 21 according to a sound inputted from the microphone. The audio processing unit 24 is capable of outputting a sound from the speaker based on an instruction from the controller 21, wireless communication module 22, or the like and thereby implementing a so-called handsfree function.

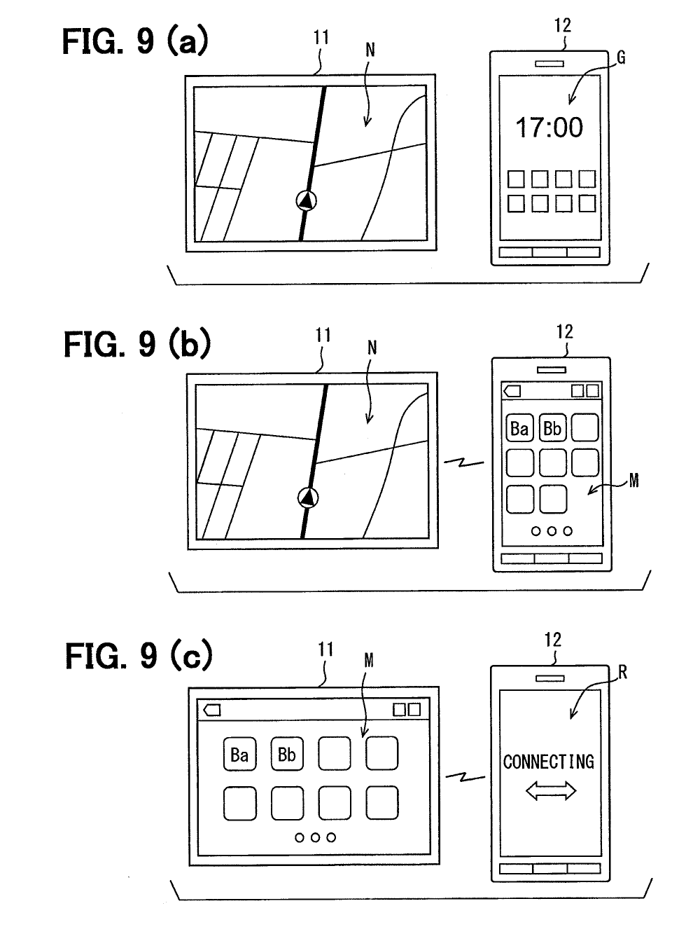

The display output unit 25 is provided by, for example, a liquid crystal display or organic EL and displays various information based on a display instruction signal from the controller 21. The screen of the display output unit 25 provides a touch panel switch of publicly known pressure sensing type, electromagnetic induction type, capacitance type, or a combination thereof. The display output unit 25 displays the following: an operational input screen for inputting an operation with respect to contents; an output screen for outputting execution details of contents; a route guidance screen N illustrated in, for example, FIG. 9(a); and the like. The operational input screen is also referred to as an input interface and the output screen is also referred to as an output interface.

The operational input unit 26 includes various switches, including a touch panel switch provided by the screen of the display output unit 25 and a mechanical switch disposed at a periphery of the display output unit 25. The operational input unit 26 outputs an operation detection signal to the controller 21 according to a user's operation with respect to the various switches. The controller 21 analyzes the operation detection signal inputted from the operational input unit 26 and identifies details of the user's operation and executes various processing based on the identified details of the operation.

The signal input unit 27 is connected to an accessory switch (ACC switch), not shown, equipped to the vehicle and inputs an ACC accessory signal (ACC signal) outputted from the ACC switch to the controller 21. The controller 21 controls turn-on or turn-off of a power supply circuit, not shown, based on the on state or off state of the inputted ACC signal. That is, the controller 21 turns on the power supply circuit when the ACC signal switches from an off state to an on state. The controller 21 turns off the power supply circuit when the ACC signal switches from the on state to the off state.

The position obtaining unit 28 includes various sensors, including publicly known geomagnetic sensor, gyro scope, vehicle speed sensor, GPS receiver, and the like none of which is shown in the drawing. The position obtaining unit 28 complements detection signals inputted from these sensors and thereby acquires the positional information of the vehicle. The position obtaining unit 28 outputs the acquired positional information of the vehicle to the controller 21. The controller 21 carries out so-called navigation processing based on the positional information of the vehicle acquired at the position obtaining unit 28, a guided route searched for by a route search unit, not shown, and the like.

The travel determination unit 31 determines whether or not the vehicle is running based on various detection signals varying corresponding to running of the vehicle. The detection signals may include the following: the speed of the vehicle detected by the vehicle speed sensor provided in the position obtaining unit 28, an accelerator opening detected by an accelerator opening sensor, not shown; change in the position of the vehicle acquired by the position obtaining unit 28; and the like.

When the travel determination unit 31 determines that the vehicle is running, the apparatus-side forbidding unit 32 forbids the in-vehicle communication apparatus 11 to provide the input interface (operational input screen) or output interface (output screen) of a predetermined content. As a result, operational input of the predetermined content to the in-vehicle communication apparatus 11 and screen output thereof from the in-vehicle communication apparatus 11 are forbidden. The operational input of the predetermined content to the in-vehicle communication apparatus 11 refers to that a user inputs an operation with respect to the predetermined content using the operational input unit 26 of the in-vehicle communication apparatus 11. The screen output of the predetermined content from the in-vehicle communication apparatus 11 refers to that the execution result of an application program of the predetermined content is displayed on the display output unit 25 of the in-vehicle communication apparatus 11. The apparatus-side forbidding unit 32 may be configured to forbid the in-vehicle communication apparatus 11 to provide an input interface or output interface of the predetermined content when the travel determination unit 31 determines that the vehicle is running. In this case, the operational input of the predetermined content to the in-vehicle communication apparatus 11 or screen output thereof from the in-vehicle communication apparatus 11 is forbidden. That is, the apparatus-side forbidding unit 32 is configured such that forbidding both the input interface and the output interface, or forbidding one of the input interface or the output interface is selectively settable corresponding to operational input characteristics or output characteristics of a content set as the predetermined content.

As the predetermined content, a content considered undesirable for the driver to operate or view an output screen during the vehicle running may be set. For example, content B may be set as the predetermined content. In this content B, a facility search service, in which operations for inputting various characters and the like are required and a large number of characters and moving images are outputted and displayed on the screen, is implemented. That is, during the vehicle running, an input interface and/or an output interface of the content B is not provided on the in-vehicle communication apparatus 11. Therefore, inputting an operation with respect to the content B through the in-vehicle communication apparatus 11 and/or outputting (screen output) the execution details of content B through the in-vehicle communication apparatus 11 is disabled. As mentioned above, a content (content B) whose input interface and/or output interface is not provided via the in-vehicle communication apparatus 11 during the vehicle running is set as the predetermined content.

What is forbidden by the apparatus-side forbidding unit 32 is operational input and/or screen output of the predetermined content set as the following content, for example: a content undesirable for the driver to operate or view an output screen during the vehicle running. Audio output such as internet radio is not viewed by the driver during the vehicle running. Therefore, the internet radio can be excluded from the contents need to be forbidden by the apparatus-side forbidding unit 32.

A description will be given to the configuration of the main mobile communication terminal (MAIN MB COMM TM) 12. The main mobile communication terminal 12 includes: a controller (CONTROLLER) 41, a wireless communication module (WS COMM MD) 42, a storage unit (STORAGE) 43, an audio processing unit (AD PROC) 44, a display output unit (DISP OUT) 45, an operational input unit (OP IN) 46, a phone communication unit (PH COMM) 47, and the like. The controller 41 is provided by a publicly known microcomputer having CPU, RAM, ROM, I/O bus, and the like none of which is shown in the drawing. The controller 41 controls the entire operation of the main mobile communication terminal 12 according to a computer program stored in ROM, the storage unit 43, or the like. The controller 41 executes a computer program and thereby provides a terminal-side forbidding unit (FORBID) 51, a providing unit (PROVIDE) 52, a content execution unit (CONT EXE) 53, a transmission unit (TRANSMIT) 54 by software.

The wireless communication module 42 establishes a radio communication line between it and the wireless communication module 22 included in the in-vehicle communication apparatus 11. The wireless communication module 42 then carries out various communications with the in-vehicle communication apparatus 11 through the radio communication line. The storage unit 43 is provided by a nonvolatile storage medium such as, for example, a memory card. The storage unit 43 stores various programs, including various computer programs and the application programs of contents, a cooperative application program for carrying out cooperative functions to execute contents cooperatively with external equipment or terminals, and data and the like used in each program.

The audio processing unit 44 is connected to a microphone and a speaker neither of which is shown in the drawing and has publicly known sound input function and sound output function. The audio processing unit 44 outputs speaking sound inputted from the microphone to the controller 41 and outputs, to the speaker, received sound inputted from the controller 41 in order to implement a so-called calling function. In addition, the audio processing unit 44 outputs an instruction for operating the main mobile communication terminal 12 or the like to the controller 41 based on a sound inputted from the microphone. The audio processing unit 44 is also capable of outputting sound from the speaker based on an instruction from the controller 41, wireless communication module 42, or the like and thereby providing a so-called handsfree function.

The display output unit 45 is provided by, for example, a liquid crystal display or an organic EL display and displays various information based on a display instruction signal from the controller 41. The screen of the display output unit 45 provides a touch panel switch of publicly known pressure sensing type, electromagnetic induction type, capacitance type, or a combination thereof. The display output unit 45 displays the following: an operational input screen for inputting an operation with respect to the contents, an output screen for outputting the execution details of contents; an ordinary menu screen G illustrated in, for example, FIG. 9(a); and the like. The operational input screen is also referred to as an input interface and the output screen is also referred to as an output interface.

The operational input unit 46 includes various switches, including the touch panel switch provided by the screen of the display output unit 45 and a mechanical switch disposed at a periphery of the display output unit 45. The operational input unit 46 outputs an operation detection signal to the controller 41 according to a user's operation with respect to the various switches. The controller 41 analyzes the operation detection signal inputted from the operational input unit 46 to identify the details of the user's operation and carries out various processing based on the identified details of the operation.

The phone communication unit 47 establishes a radio communication line between it and a communication network (COMM NETWORK) 100 and carries out telephone communication through the radio communication line. In this case, the communication network 100 includes facilities, such as cellular phone base stations and base station controllers neither of which is shown in the drawing, that provide cellular phone communication service using a publicly known public network. The controller 41 acquires the application programs and data of various contents from a provide center 14 connected to the communication network 100 through the phone communication unit 47.

The terminal-side forbidding unit 51 is enabled when the mobile communication terminal is connected as main mobile communication terminal in a communicable manner to the in-vehicle communication apparatus 11. The terminal-side forbidding unit 51 forbids the main mobile communication terminal 12 to provide the input interface and the output interface of all the contents that can be executed by the main mobile communication terminal 12. In order to forbid the operational input of all the contents to the main mobile communication terminal and the screen output of all the contents from the main mobile communication terminal. In this case, at the main mobile communication terminal 12, the terminal-side forbidding unit 51 is enabled. Therefore, as the result of the terminal-side forbidding unit 51 operating, every content that can be executed on the main mobile communication terminal 12 cannot be operated or outputted from the main mobile communication terminal 12.

The operational input of contents to the main mobile communication terminal refers to that a user inputs an operation with respect to the contents to the operational input unit 46 of the main mobile communication terminal. The screen output of contents from the main mobile communication terminal refers to that the execution result of an application program of the contents is displayed on the display output unit 45 of the main mobile communication terminal.

The providing unit 52 is enabled at the sub mobile communication terminal when the mobile communication terminal is connected as the sub mobile communication terminal in a communicable manner to the main mobile communication terminal 12. The providing unit 52 provides, to the sub mobile communication terminal, an input interface and an output interface of the predetermined content whose operational input to the in-vehicle communication apparatus 11 and screen output from the in-vehicle communication apparatus 11 are forbidden by the apparatus-side forbidding unit 32, or the providing unit 52 provides, to the sub mobile communication terminal, the input interface or the output interface of the predetermined content whose operational input to the in-vehicle communication apparatus 11 or screen output from the in-vehicle communication apparatus 11 is forbidden by the apparatus-side forbidding unit 32. With this configuration, the providing unit 52 enables an operation performed to the sub mobile communication terminal with respect to the predetermined content and/or a screen output of the predetermined content from the sub mobile communication terminal. In this case, the predetermined content whose operational input to the sub mobile communication terminal and/or screen output from the sub mobile communication terminal is enabled is the predetermined content whose operational input to the in-vehicle communication apparatus 11 and/or screen output from the in-vehicle communication apparatus 11 is forbidden. In this case, at the main mobile communication terminal 12, the providing unit 52 is disabled. That is, the providing unit 52 does not provide the following to the main mobile communication terminal 12: the input interface or the output interface of the predetermined content whose operational input to the in-vehicle communication apparatus 11 and screen output from the in-vehicle communication apparatus 11 are forbidden by the apparatus-side forbidding unit 32; or the input interface or the output interface of the predetermined content whose operational input to the in-vehicle communication apparatus 11 or screen output from the in-vehicle communication apparatus 11 is forbidden by the apparatus-side forbidding unit 32. Therefore, the operational input and/or the screen output of the predetermined content whose operational input to the in-vehicle communication apparatus 11 and/or screen output from the in-vehicle communication apparatus 11 is forbidden cannot be carried out in the main mobile communication terminal 12.

The content execution unit 53 is enabled when the mobile communication terminal is connected as the main mobile communication terminal in a communicable manner to the in-vehicle communication apparatus 11. Based on the operation performed on the external in-vehicle communication apparatus 11 or the external sub mobile communication terminal 13, the content execution unit 53 executes application programs of contents according to the operational input and carries out corresponding data processing or the like. In the following description, execution of contents refers to that an application included in the contents is carried out and corresponding data processing or the like is carried out. That is, the in-vehicle communication system 10 executes contents at the main mobile communication terminal 12 based on the operational input performed to external equipment or external terminal other than the main mobile communication terminal 12. The content execution unit 53 is disabled when the mobile communication terminal is connected as the sub mobile communication terminal in a communicable manner to the main mobile communication terminal. When the mobile communication terminal is not set as the main mobile communication terminal 12 or the sub mobile communication terminal 13, that is, when the mobile communication terminal exists as single body separated from the main or the sub mobile communication terminal, the mobile communication terminal singly executes contents based on the operation performed to the mobile communication terminal according to the operational input.

The transmission unit 54 is enabled when the mobile communication terminal is connected as the main mobile communication terminal in a communicable manner to the in-vehicle communication apparatus 11. It outputs the following output data to at least one of the in-vehicle communication apparatus 11 or the sub mobile communication terminal 13 through the wireless communication module 42: output data indicating the details of output of contents (the execution result of an application program of contents) by the content execution unit 53.

A description will be given to the configuration of the sub mobile communication terminal (SUB MB COMM TM) 13. The sub mobile communication terminal 13 includes: a controller (CONTROLLER) 61, a wireless communication module (WS COMM MD) 62, a storage unit (STORAGE) 63, an audio processing unit (AD PROC) 64, a display output unit (DISP OUT) 65, an operational input unit (OP IN) 66, a phone communication unit (PH COMM) 67, and the like. The controller 61 executes a computer program and thereby virtually provides a terminal-side forbidding unit (FORBID) 71, a providing unit (PROVIDE) 72, a content execution unit (CONT EXE) 73, and a transmission unit (TRANSMIT) 74 by software.

The function of the wireless communication module 62 is similar to the function of the wireless communication module 42 included in the main mobile communication terminal 12, the function of the storage unit 63 is similar to the function of the storage unit 43 included in the main mobile communication terminal 12, the function of the audio processing unit 64 is similar to the function of the audio processing unit 44 included in the main mobile communication terminal 12, the function of the display output unit 65 is similar to the function of the display output unit 45 included in the main mobile communication terminal 12, the function of the operational input unit 66 is similar to the function of the operational input unit 46 included in the main mobile communication terminal 12, and the function of the phone communication unit 67 is similar to the function of the phone communication unit 47 included in the main mobile communication terminal 12. However, the wireless communication module 62 establishes the radio communication line between it and the wireless communication module 42 of the main mobile communication terminal 12, not between it and the wireless communication module 22 of the in-vehicle communication apparatus 11. Then, the wireless communication module 62 carries out various communications with the main mobile communication terminal 12, not with the in-vehicle communication apparatus 11. The phone communication unit 67 is capable of establishing the radio communication line between it and the communication network 100 and carrying out the telephone communication. However, the controller 61 is incapable of acquiring various contents or data from the provide center 14 through the phone communication unit 47, and is configured to acquire various contents and data through the main mobile communication terminal 12.

The functions of the terminal-side forbidding unit 71, the providing unit 72, the content execution unit 73, and the transmission unit 74 are also, respectively, similar to the following functions: the above-mentioned functions of the terminal-side forbidding unit 51, the providing unit 52, the content execution unit 53, and the transmission unit 54. In this case, the terminal-side forbidding unit 71, the content execution unit 73, and the transmission unit 74 are disabled and the providing unit 72 is enabled. Therefore, operation and output of all the contents that can be executed at the main mobile communication terminal 12 can be carried out on the sub mobile communication terminal 13. As the result of the providing unit 72 operating, the operational input with respect to the predetermined content on the sub mobile communication terminal 13 and/or the screen output of the predetermined content on the sub mobile communication terminal 13 can also be carried out.

The operational input of contents to the sub mobile communication terminal refers to that a user inputs an operation to the operational input unit 66 of the sub mobile communication terminal with respect to the contents. The screen output of contents from the sub mobile communication terminal refers to that the execution result of an application program of the contents is displayed on the display output unit 65 of the sub mobile communication terminal.

When the above-mentioned in-vehicle communication apparatus 11, the main mobile communication terminal 12, and the sub mobile communication terminal 13 are connected in a communicable manner with one another to configure the in-vehicle communication system 10, the following is implemented: contents acquired from the provide center 14 by the main mobile communication terminal 12 can be executed cooperatively with one another. This is done by starting a cooperative application program provided in each of the in-vehicle communication apparatus 11, the main mobile communication terminal 12, and the sub mobile communication terminal 13. A description will be given to an operation carried out when the in-vehicle communication apparatus 11, the main mobile communication terminal 12, and the sub mobile communication terminal 13 execute contents cooperatively with one another. In the following description, the cooperative application program will be abbreviated and referred to as a cooperative application.

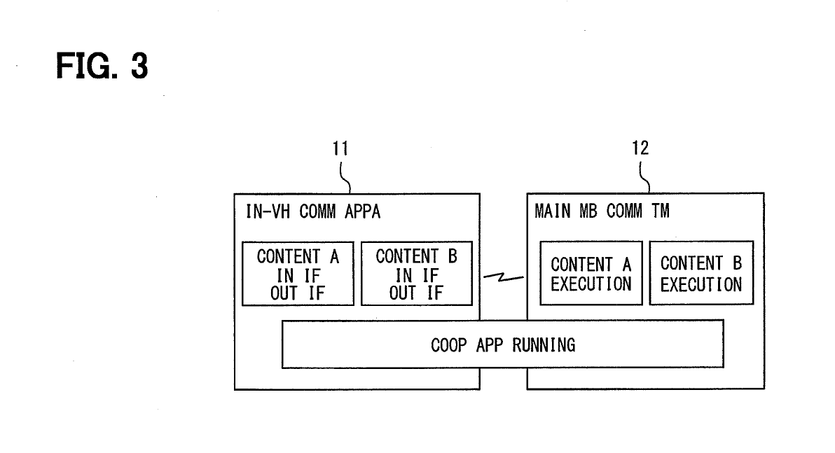

In a case illustrated in FIG. 3, the vehicle is not running and the main mobile communication terminal 12 is connected in a communicable manner to the in-vehicle communication apparatus 11. Under this connection state, when the cooperative application (COOP APP) provided in each of the in-vehicle communication apparatus 11 and the main mobile communication terminal 12 is started, the input interfaces (IN IF) and the output interfaces (OUT IF) of all contents A, B provided in the main mobile communication terminal 12 are provided at the in-vehicle communication apparatus 11 and execution processing is carried out at the main mobile communication terminal 12.

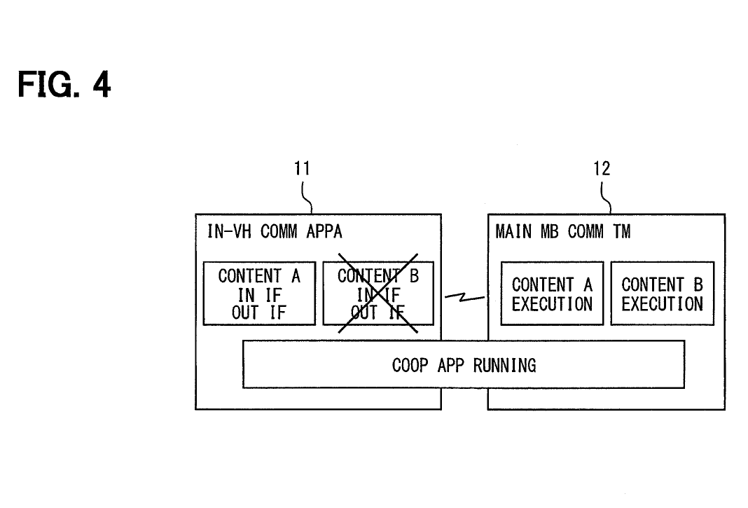

When the vehicle starts running, as illustrated in FIG. 4, the in-vehicle communication apparatus 11 is forbidden to provide the input interface and/or the output interface of a content B among contents A, B that can be executed by the main mobile communication terminal 12. In this state, the content B cannot be utilized from the in-vehicle communication apparatus 11 or the main mobile communication terminal 12.

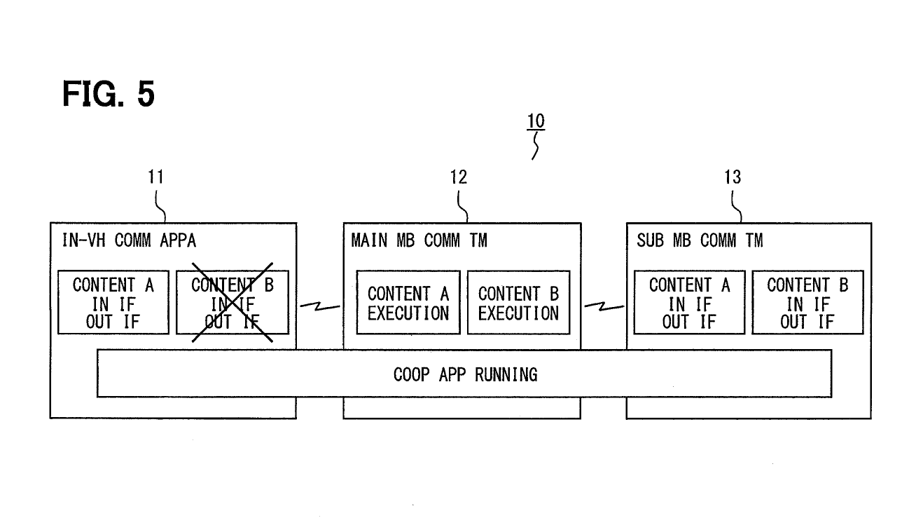

When the vehicle is running, as illustrated in FIG. 5, the sub mobile communication terminal 13 is connected in a communicable manner to the main mobile communication terminal 12, and the in-vehicle communication system 10 is configured. Also at the sub mobile communication terminal 13, the cooperative application is started. As a result, the input interface and/or the output interface of the content B, which is forbidden from being provided at the in-vehicle communication apparatus 11, is provided from the sub mobile communication terminal 13. Consequently, the content B can be utilized from the sub mobile communication terminal 13. At this time, the sub mobile communication terminal 13 is also capable of providing an input interface and/or an output interface of the content A. Thus content A can be utilized from not only the in-vehicle communication apparatus 11 but also from the sub mobile communication terminal 13.

A description will be given to the operation of the in-vehicle communication system 10 configured as mentioned above with reference to flowcharts. The processing described below is control processing carried out by the controller 21 of the in-vehicle communication apparatus 11, the controller 41 of the main mobile communication terminal 12, and the controller 61 of the sub mobile communication terminal 13. The description will be given with each of the in-vehicle communication apparatus 11, the main mobile communication terminal 12, and the sub mobile communication terminal 13 at the nucleus.

(Processing Executed by in-Vehicle Communication Apparatus)

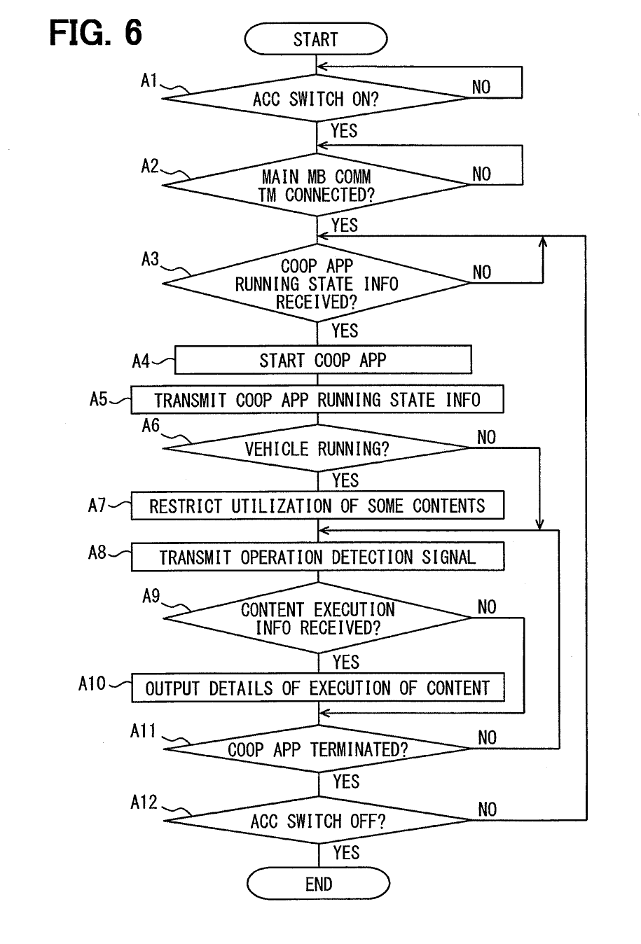

As illustrated in FIG. 6, when the ACC switch of the vehicle is turned on at Step A1 (Step A1: YES), the in-vehicle communication apparatus 11 monitors whether or not a mobile communication terminal is connected to the in-vehicle communication apparatus 11 as the main mobile communication terminal in a communicable manner to the in-vehicle communication apparatus 11. When the main mobile communication terminal 12 is connected in a communicable manner (Step A2: YES), the in-vehicle communication apparatus 11 monitors whether or not cooperative application running state information is received from the main mobile communication terminal 12. The screen of the in-vehicle communication apparatus 11 is set such that no change occurs on the screen even when the main mobile communication terminal 12 is connected in a communicable manner to the in-vehicle communication apparatus 11 as illustrated in FIG. 9(b). The cooperative application running state information includes at least information indicating that a cooperative application is running at each apparatus or each terminal (in-vehicle communication apparatus 11). The cooperative application running state information may further include information related to the contents that can be executed by the cooperative application, for example, information indicating the names, details, functions, and the like of contents.

When the in-vehicle communication apparatus 11 receives cooperative application running state information from the main mobile communication terminal 12 (Step A3: YES), the in-vehicle communication apparatus 11 starts the cooperative application provided in the in-vehicle communication apparatus 11 according to a user's operation at Step A4. As a result, the screen of the in-vehicle communication apparatus 11 transitions to the menu screen M of the cooperative application as illustrated in FIG. 9(c). The menu screen M is provided with start buttons for starting various contents, such as a start button Ba for starting the content A and a start button Bb for starting the content B.

When the cooperative application is started, the in-vehicle communication apparatus 11 transmits cooperative application running state information to the main mobile communication terminal 12 at Step A5. At Step A6, the in-vehicle communication apparatus 11 determines whether or not the vehicle is running. When the vehicle is running (Step A6: YES), at Step A7, the in-vehicle communication apparatus 11 carries out the following processing with respect to the contents A, B that can be executed by the main mobile communication terminal 12: the in-vehicle communication apparatus 11 allows the in-vehicle communication apparatus 11 to provide an input interface and/or an output interface of the content A that is not set as the predetermined content to permit the utilization of the content A; and the in-vehicle communication apparatus 11 forbids the in-vehicle communication apparatus 11 to provide an input interface and/or an output interface of the content B that is set as the predetermined content to restrict the utilization of the content B. The in-vehicle communication apparatus 11 then proceeds to Step A8.

When the vehicle is not running (Step A6: NO), the in-vehicle communication apparatus 11 does not restrict the utilization of some contents (content B). The in-vehicle communication apparatus 11 provides input interfaces and output interfaces of all contents A, B that can be executed by the main mobile communication terminal 12 and proceeds to Step A8. When the in-vehicle communication apparatus 11 does not have data required for providing input interfaces and output interfaces of contents, the in-vehicle communication apparatus 11 can acquire the data from the provide center 14 through the main mobile communication terminal 12.

At Step A8, the in-vehicle communication apparatus 11 transmits an operation detection signal inputted from the operational input unit 26 to the main mobile communication terminal 12. When the vehicle is not running at this time, the in-vehicle communication apparatus 11 can transmit the operation detection signal related to the content A and transmit the operation detection signal related to the content B to the main mobile communication terminal 12. When the vehicle is running, the in-vehicle communication apparatus 11 can transmit the operation detection signal related to the content A to the main mobile communication terminal 12 but cannot transmit the operation detection signal related to content B.

At Step A9, while the in-vehicle communication apparatus 11 transmits the operation detection signal to the main mobile communication terminal 12 from time to time, the in-vehicle communication apparatus 11 monitors whether or not content execution information is received from the main mobile communication terminal 12. When the in-vehicle communication apparatus 11 receives the content execution information from the main mobile communication terminal 12, the in-vehicle communication apparatus 11 outputs, at Step A10, the execution details of contents based on the content execution information.

When the vehicle is not running at this time, the in-vehicle communication apparatus 11 can output the execution details of the content A based on the content execution information related to the content A; and the in-vehicle communication apparatus 11 can output the execution details of the content B based on the content execution information related to the content B. When the vehicle is running, the in-vehicle communication apparatus 11 can output the execution details of the content A based on the content execution information related to the content A; but the in-vehicle communication apparatus 11 cannot output the execution details of the content B based on the content execution information related to the content B.

The in-vehicle communication apparatus 11 transmits the operation detection signal to the main mobile communication terminal 12 (Step A8) and outputs the execution details of contents based on received content execution information (Step A10). While the in-vehicle communication apparatus 11 carries out these processing steps from time to time, at Step A11, the in-vehicle communication apparatus 11 monitors whether or not the cooperative application running in the in-vehicle communication apparatus 11 is terminated. When the cooperative application is running (Step A11: NO), the in-vehicle communication apparatus 11 proceeds to Step A8. When the cooperative application is terminated (Step A11: YES), at Step A12, the in-vehicle communication apparatus 11 confirms whether or not the ACC switch of the vehicle is turned off. When the ACC switch is not turned off (Step A12: NO), the in-vehicle communication apparatus 11 proceeds to Step A3. When the ACC switch is turned off (Step A12: YES), the in-vehicle communication apparatus 11 ends this series of control processing.

(Processing Executed by Main Mobile Communication Terminal)

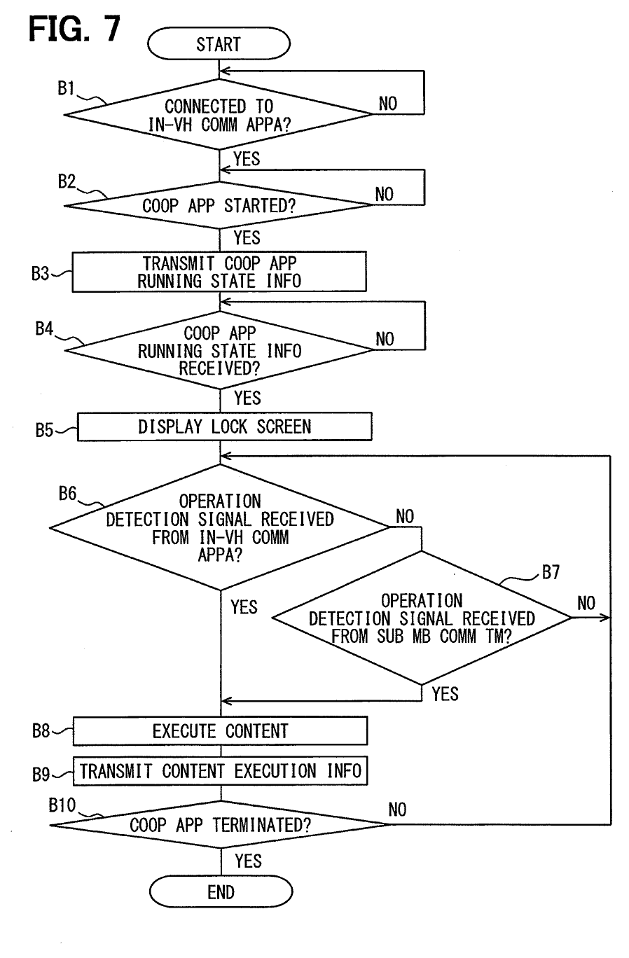

As illustrated in FIG. 7, when a mobile communication terminal is started, at Step B1, the mobile communication terminal monitors whether or not the mobile communication terminal itself is connected in a communicable manner to the in-vehicle communication apparatus 11. When the mobile communication terminal is connected in a communicable manner to the in-vehicle communication apparatus 11 (Step B1: YES), at Step B2, the mobile communication terminal, as the main mobile communication terminal 12, monitors whether or not the cooperative application is started at the main mobile communication terminal 12.

When the cooperative application is started according to a user's operation (Step B2: YES), at Step B3, the mobile communication terminal 12 transmits cooperative application running state information to the in-vehicle communication apparatus 11 and the mobile communication terminal 13. Further, as illustrated in FIG. 9(b), the mobile communication terminal 12 is connected as the main mobile communication terminal in a communicable manner to the in-vehicle communication apparatus 11, and the screen of the bile communication terminal transitions to the menu screen M of the cooperative application. The menu screen M is provided with start buttons for starting various contents, such as the start button Ba for starting the content A and the start button Bb for starting the content B.

At Step B4, the main mobile communication terminal 12 monitors whether or not the cooperative application running state information is received from the in-vehicle communication apparatus 11. When the cooperative application running state information is received from the in-vehicle communication apparatus 11 (Step B4: YES), as illustrated in FIG. 9(c), the main mobile communication terminal 12, at Step B5, causes the screen of the main mobile communication terminal 12 to transition to lock screen R. As a result, operation on the main mobile communication terminal 12 is forbidden with respect to all the contents A, B. At this time, the cooperative application stays running at the main mobile communication terminal 12 and the contents are executed based on the operation detection signal inputted from external equipment or terminal.

After displaying the lock screen R, the main mobile communication terminal 12, at Step B6, monitors whether or not the operation detection signal is received from the in-vehicle communication apparatus 11. At Step B7, the main mobile communication terminal 12 monitors whether or not the operation detection signal is received from the sub mobile communication terminal 13. When the operation detection signal is received from the in-vehicle communication apparatus 11 (Step B6: YES) or received from the sub mobile communication terminal 13 (Step B7: YES), the main mobile communication terminal 12, at Step B8, executes a content based on the received operation detection signal.

At Step B9, the main mobile communication terminal 12 transmits the content execution information for outputting the execution details of the executed content to the in-vehicle communication apparatus 11 or the sub mobile communication terminal 13. The main mobile communication terminal 12 is configured such that, when the operation detection signal is received from the in-vehicle communication apparatus 11 (Step B6: YES), the main mobile communication terminal 12 transmits the content execution information to the in-vehicle communication apparatus 11. The main mobile communication terminal 12 is configured such that, when the operation detection signal is received from the sub mobile communication terminal 13 (Step B7: YES), the main mobile communication terminal 12 transmits the content execution information to the sub mobile communication terminal 13. Further, the main mobile communication terminal 12 may also be configured such that, when the operation detection signal is received from the in-vehicle communication apparatus 11, the main mobile communication terminal 12 transmits the content execution information to the sub mobile communication terminal 13. Further, the main mobile communication terminal 12 may also be configured such that, when the operation detection signal is received from the sub mobile communication terminal 13, the main mobile communication terminal 12 transmits the content execution information to the in-vehicle communication apparatus 11. Alternatively, the main mobile communication terminal 12 may also be configured to select a target to which the content execution information should be transmitted according to the execution result of the content or the like.

The main mobile communication terminal 12 receives the operation detection signal from the in-vehicle communication apparatus 11 or from the sub mobile communication terminal 13, executes a content based on the received operation detection signal, and transmits the content execution information from time to time. While the main mobile communication terminal 12 carries out these process steps, at Step B10, the main mobile communication terminal 12 monitors whether or not the cooperative application running in the main mobile communication terminal 12 is terminated. When the cooperative application is terminated (Step B10: YES), the main mobile communication terminal 12 ends this series of processing.

(Processing Executed by Sub Mobile Communication Terminal)

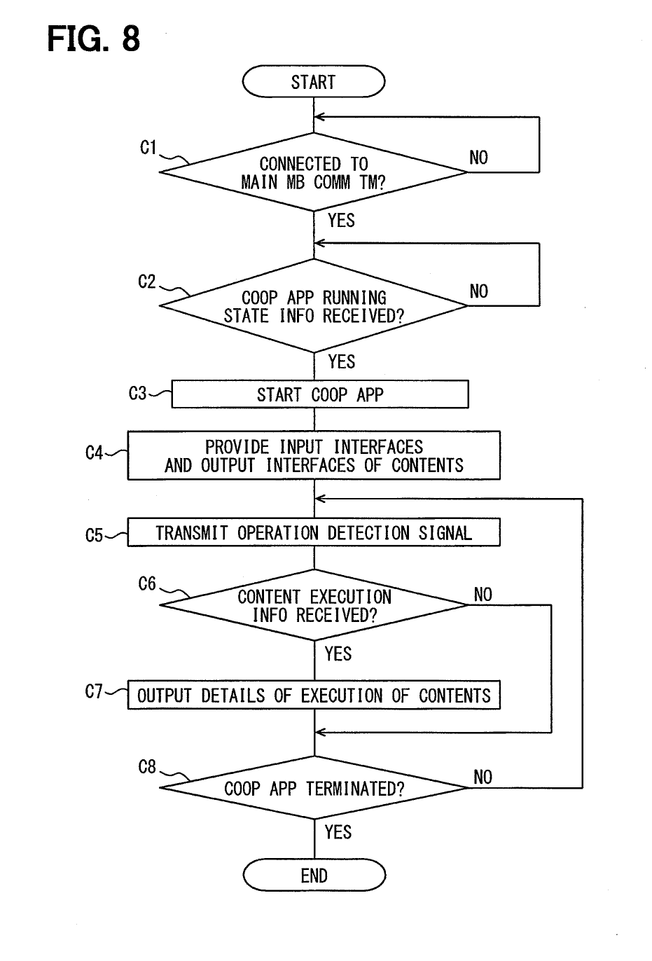

As illustrated in FIG. 8, when a mobile communication terminal is started, at Step C1, the mobile communication terminal monitors whether or not the mobile communication terminal itself is connected in a communicable manner to the main mobile communication terminal 12. When the mobile communication terminal is connected in a communicable manner to the main mobile communication terminal 12 (Step C1: YES), at Step C2, the mobile communication terminal, as the sub mobile communication terminal 13, monitors whether or not the cooperative application running state information is received from the main mobile communication terminal 12. When the cooperative application running state information is received from the main mobile communication terminal 12 (Step C2: YES), at Step C3, the sub mobile communication terminal 13 starts the cooperative application provided in the sub mobile communication terminal 13 according to a user's operation.

At Step C4, the sub mobile communication terminal 13 provides, from the sub mobile communication terminal 13, the input interfaces and the output interfaces of all the contents A, B that can be executed by the main mobile communication terminal 12. When the sub mobile communication terminal 13 does not have data required for providing the input interfaces and the output interfaces of the contents, the sub mobile communication terminal 13 acquires the required data from the provide center 14 through the main mobile communication terminal 12.

The sub mobile communication terminal 13 proceeds to Step C5 and transmits the operation detection signal inputted from the operational input unit 66 to the main mobile communication terminal 12. At this time, the sub mobile communication terminal 13 is capable of transmitting the following to the main mobile communication terminal 12 regardless of whether or not the vehicle is running: the operation detection signal related to the content A and the operation detection signal related to the content B.

At Step C6, while transmitting the operation detection signal to the main mobile communication terminal 12, the sub mobile communication terminal 13 monitors whether or not the content execution information is received from the main mobile communication terminal 12. When the content execution information is received from the main mobile communication terminal 12 (Step C6: YES), at Step C7, the sub mobile communication terminal 13 outputs the execution details of the contents from the sub mobile communication terminal 13 based on the content execution information. At this time, regardless of whether or not the vehicle is running, the sub mobile communication terminal 13 is capable of outputting the execution details of the content A based on the content execution information related to the content A and the execution details of the content B based on the content execution information related to the content B.

The sub mobile communication terminal 13 transmits the operation detection signal to the main mobile communication terminal 12 and outputs the execution details of the contents based on the received content execution information. While the sub mobile communication terminal 13 carries out these processing steps from time to time, at Step C8, the sub mobile communication terminal 13 monitors whether or not the cooperative application running at the sub mobile communication terminal 13 is terminated. When the cooperative application is terminated (Step C8: YES), the sub mobile communication terminal 13 ends this series of processing.

A description will be given to operations carried out when the predetermined content (content B providing facility search service) is utilized by the above-mentioned in-vehicle communication apparatus 11, the main mobile communication terminal 12, and the sub mobile communication terminal 13.

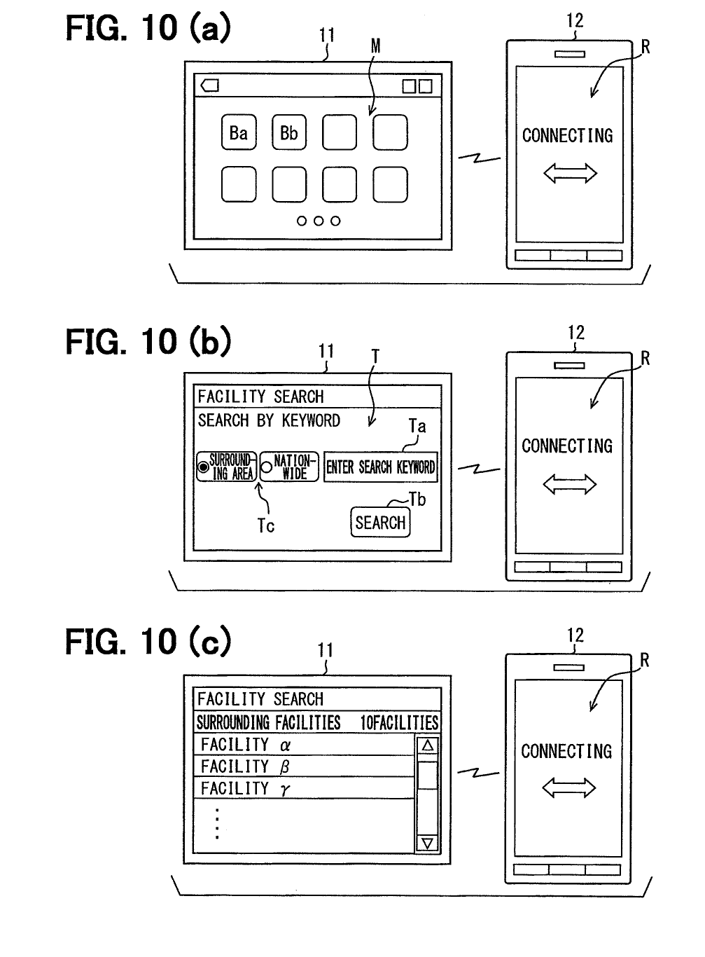

The following will describe, with reference to FIG. 10(a) to FIG. 10(c), a case in which the content B is utilized by the in-vehicle communication apparatus 11 and the main mobile communication terminal 12. That is, a case in which the content B is utilized in the absence of the sub mobile communication terminal 13 will be described. When the start button Bb for the content B is operated from the menu screen M displayed on the in-vehicle communication apparatus 11, as illustrated in FIG. 10(a), under a vehicle stop state, the content B is started at the main mobile communication terminal 12 and the execution details of the content B are outputted from the in-vehicle communication apparatus 11. As a result, a top screen T of the content B is displayed on the screen of the in-vehicle communication apparatus 11 as illustrated in FIG. 10(b).

The top screen T is provided with: a keyword input portion Ta for inputting a keyword used for facility search, a search button Tb for carrying out search, a search area specifying portion Tc for specifying a search area, and the like. Any operation such as an operation of inputting a keyword into the keyword input portion Ta, an operation with search button Tb, an operation of specifying the search area with the search area specifying portion Tc, or the like is carried out. When one of above-described operations is detected, the in-vehicle communication apparatus 11 transmits the operation detection signal corresponding to the operation to the main mobile communication terminal 12. The main mobile communication terminal 12 carries out a search processing under the content B according to the operation detection signal received from the in-vehicle communication apparatus 11. Then, the main mobile communication terminal 12 transmits the content execution information indicating the execution result (search result) to the in-vehicle communication apparatus 11.

The in-vehicle communication apparatus 11 displays the content execution information received from the main mobile communication terminal 12, that is, the result of facility search on the screen of the in-vehicle communication apparatus 11 as illustrated in FIG. 10(c). Thus the user can enter any keyword into the keyword input portion Ta and operate the search button Tb to search for facilities. The in-vehicle communication apparatus 11 can set a found facility as, for example, the destination of route guidance. When multiple facilities are found, the in-vehicle communication apparatus 11 is capable of selectably displaying the facilities in list form.

When the vehicle starts running, for example, during an input operation in which the user inputs a keyword into the keyword input portion Ta in the above-mentioned search processing using the content B, the in-vehicle communication apparatus 11 disables the top screen T to forbid inputting a keyword into the in-vehicle communication apparatus 11. As long as the vehicle is running, the in-vehicle communication apparatus 11 keeps top screen T disabled. When the vehicle stops, the in-vehicle communication apparatus 11 enables the top screen T to permit inputting a keyword into the in-vehicle communication apparatus 11. That is, when the vehicle is running, the in-vehicle communication apparatus 11 disables the input interface (top screen T) of the content B and thereby forbids the utilization of the content B from the in-vehicle communication apparatus 11.

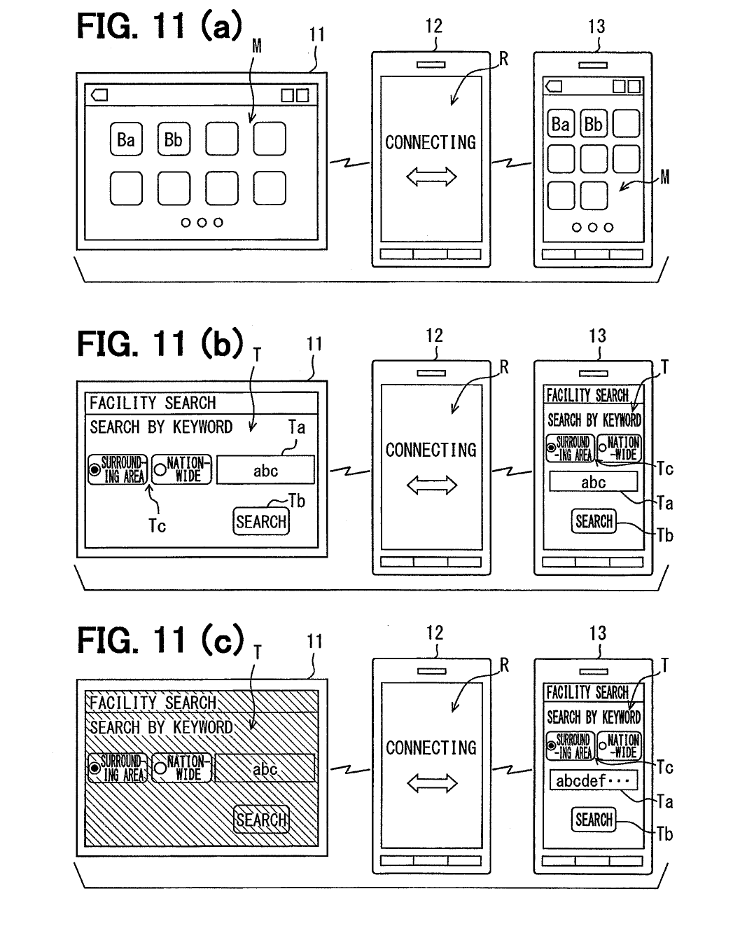

The following will describe, with reference to FIG. 11(a) to FIG. 11(c), a case in which the cooperative application has been started at the sub mobile communication terminal from before the vehicle starts running. When the vehicle is not running and the start button Bb for the content B is operated from the menu screen M displayed on the in-vehicle communication apparatus 11 as illustrated in FIG. 11(a), the content B is started at the main mobile communication terminal 12 based on the operation detection signal and the execution details of the content B are outputted from the in-vehicle communication apparatus 11. As a result, the top screen T of the content B is displayed on the screen of the in-vehicle communication apparatus 11 as illustrated in FIG. 11(b). In addition, as illustrated in FIG. 11(a), as the result of the cooperative application being started, the menu screen M is displayed on the screen of the sub mobile communication terminal 13. The main mobile communication terminal 12 transmits the execution details of the content B based on the operation detection signal received from the in-vehicle communication apparatus 11 also to the sub mobile communication terminal 13. With the transition of the screen of the in-vehicle communication apparatus 11, consequently, the same details as on the screen of the in-vehicle communication apparatus 11 are displayed also on the screen of the sub mobile communication terminal 13 as illustrated in FIG. 11(b).

When the vehicle starts running, for example, during the input operation in which the user inputs a keyword into the keyword input portion Ta in the above-mentioned search processing using the content B, the in-vehicle communication apparatus 11 disables the top screen T displayed on the screen of the in-vehicle communication apparatus 11 as illustrated in FIG. 11(c) to forbid inputting a keyword into the in-vehicle communication apparatus 11. The sub mobile communication terminal 13 does not disable the top screen T displayed on the screen of the sub mobile communication terminal 13 and permits inputting a keyword into the sub mobile communication terminal 13 even when the vehicle starts running. Thus even when the vehicle is running, the user can input a keyword from the sub mobile communication terminal 13 without interruption and continue the search processing using the content B.

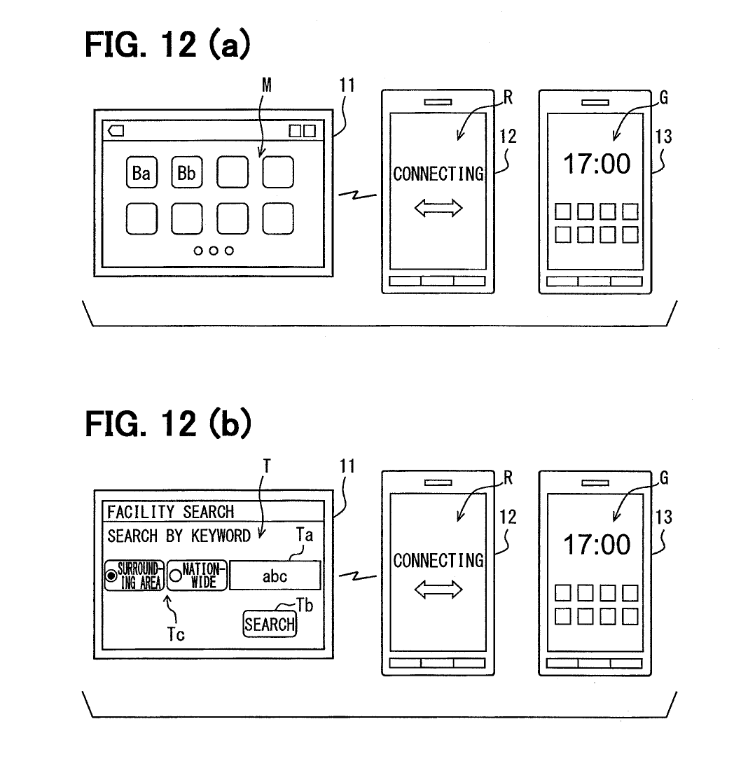

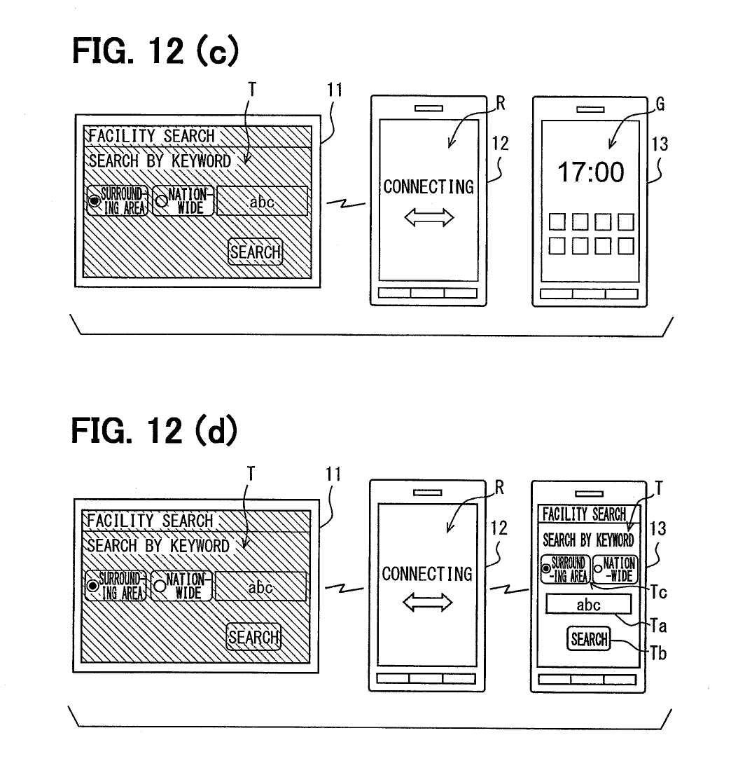

The following will describe, with reference to FIG. 12(a) to FIG. 12(d), a case in which the vehicle starts running and the cooperative application is thereafter started at the sub mobile communication terminal. When the vehicle has not started running yet and the start button Bb for the content B is operated from the menu screen M displayed on the in-vehicle communication apparatus 11 as illustrated in FIG. 12(a), the content B is started at the main mobile communication terminal 12 and the execution details of the content B are outputted from the in-vehicle communication apparatus 11. As a result, the top screen T for the content B is displayed on the screen of the in-vehicle communication apparatus 11 as illustrated in FIG. 12(b).

When the vehicle starts running, for example, during the input operation in which the user inputs a keyword into the keyword input portion Ta in the above-mentioned search processing using the content B, the in-vehicle communication apparatus 11 disables the top screen T to forbid inputting a keyword into the in-vehicle communication apparatus 11 as illustrated in FIG. 12(c). In this state, the content B can be operated neither from the in-vehicle communication apparatus 11 nor from the main mobile communication terminal 12.

A user other than the driver starts the cooperative application with the sub mobile communication terminal 13. As a result, the menu screen M is displayed on the screen of the sub mobile communication terminal 13. When the cooperative application is started at the sub mobile communication terminal 13, the main mobile communication terminal 12 transmits the execution details of the content B based on the operation detection signal already received from the in-vehicle communication apparatus 11 to the sub mobile communication terminal 13.

As a result, the execution details of the content B already outputted to the screen of the in-vehicle communication apparatus 11 when the vehicle starts running, are displayed on the screen of the sub mobile communication terminal 13 as illustrated in FIG. 12(d). Therefore, when the cooperative application is started at the sub mobile communication terminal 13, the screen of the sub mobile communication terminal 13 automatically transitions to the top screen T in the state in which the keyword is partway inputted into the keyword input portion Ta. Thus even when the vehicle is running, a user other than the driver can input a keyword into the sub mobile communication terminal 13 without interruption and continue the search processing using the content B.

According to the present embodiment as described above, when the vehicle is not running and a mobile communication terminal supposed not to be in possession of the driver is connected as the main mobile communication terminal 12 in a communicable manner to the in-vehicle communication apparatus 11, the utilization of all the contents A, B that can be executed at the main mobile communication terminal 12 from the main mobile communication terminal 12 is forbidden. These contents A, B become utilizable from the in-vehicle communication apparatus 11. When the vehicle starts running in this state, the utilization of the content B from the in-vehicle communication apparatus 11 is forbidden. That is, the content B can be utilized neither from the in-vehicle communication apparatus 11 nor from the main mobile communication terminal 12. The content B whose utilization from the main mobile communication terminal 12 or the in-vehicle communication apparatus 11 is forbidden becomes utilizable from the sub mobile communication terminal 13, which is supposed to be in possession of a user other than the driver. Thus any possessor of the sub mobile communication terminal 13, that is, any user, other than the driver, considered not to affect a driving safety even if the user utilizes the content B during vehicle running becomes able to utilize the content B from the sub mobile communication terminal 13 in possession thereof even during vehicle running.

Various contents are so configured that the main mobile communication terminal 12 executes them based on the operation detection signal inputted from the in-vehicle communication apparatus 11 or the sub mobile communication terminal 13. That is, the contents are executed at the main mobile communication terminal 12 that acquires the contents directly from the provide center 14. Therefore, when there is, for example, absent necessary data, the data can be immediately distributed from the provide center 14 to the main mobile communication terminal 12. Thus, this configuration provides a time saving and trouble in transmitting contents or data acquired from the provide center 14 to the in-vehicle communication apparatus 11 or the sub mobile communication terminal 13 is restricted. The contents and the data acquired from the provide center 14 by the main mobile communication terminal 12 may be further transmitted to the in-vehicle communication apparatus 11 or the sub mobile communication terminal 13. The contents may be executed at the in-vehicle communication apparatus 11 or at the sub mobile communication terminal 13.

At the main mobile communication terminal 12, the utilization of all the contents A, B that can be executed at the main mobile communication terminal 12 is forbidden by the terminal-side forbidding unit 51. With this configuration, the utilization of all contents A, B from the main mobile communication terminal 12 supposed to be in possession of the driver is forbidden, and safety is further enhanced.

At the in-vehicle communication apparatus 11, the utilization of all the contents A, B that can be executed at the main mobile communication terminal 12 is not forbidden by the apparatus-side forbidding unit 32. Instead, the utilization of some predetermined content (content B) among these contents A, B, is forbidden. That is, not all contents A, B, from the in-vehicle communication apparatus 11, but the utilization of the content B considered undesirable for the driver to operate during vehicle running is forbidden. This prevents over-restriction of the utilization of the predetermined content exceeding a necessary degree.

The content execution processing itself is carried out at the main mobile communication terminal 12. Thus, the processing load on the in-vehicle communication apparatus 11 can be reduced. As a result, the in-vehicle communication apparatus 11 can carry out other processing, for example, processing that has a heavy load such as operation control of the vehicle according to the running state of vehicle, without undue stress

(Modifications)

The sub mobile communication terminal 13 may be connected in a communicable manner to the in-vehicle communication apparatus 11, not to the main mobile communication terminal 12. The sub mobile communication terminal 13 may be configured such that the sub mobile communication terminal 13 can select either the in-vehicle communication apparatus 11 or the main mobile communication terminal 12 as a connection target.

There may be multiple sub mobile communication terminals 13. The in-vehicle communication apparatus 11, the main mobile communication terminal 12, and the sub mobile communication terminal 13 may be connected in a communicable manner with one another via a wired communication line.

A configuration for implementing the processing described below may be adopted. The identification number (phone number, serial number, or the like) of a mobile communication terminal in possession of the vehicle driver is registered into the in-vehicle communication apparatus 11. The in-vehicle communication apparatus 11 compares the identification number of a mobile communication terminal connected in a communicable manner with the registered identification number and identifies the possessor of the mobile communication terminal based on the comparison. When the identified possessor is the driver, the mobile communication terminal is set as main mobile communication terminal. A configuration for implementing the processing described below may be adopted. The identification number of a mobile communication terminal in possession of a user other than the vehicle driver is registered into the mobile communication terminal. A mobile communication terminal set as main mobile communication terminal compares the identification number of any other mobile communication terminal connected in a communicable manner with the registered identification number. The mobile communication terminal identifies the possessor of the other mobile communication terminal based on the comparison. When the identified possessor is a user other than the driver, the mobile communication terminal is set as sub mobile communication terminal.

In the above example, a car navigation system is described as an example of the in-vehicle communication apparatus 11. The in-vehicle communication apparatus 11 may also be provided by any equipment other than the car navigation system. For example, equipment in which an application program having a guidance function is installed, may be adopted as the in-vehicle communication apparatus. The in-vehicle communication apparatus may be provided by, for example, a portable wireless apparatus detachable from a vehicle as well as an in-vehicle apparatus equipped to a vehicle.

While the disclosure has been described with reference to preferred embodiments thereof, it is to be understood that the disclosure is not limited to the preferred embodiments and constructions. The disclosure is intended to cover various modification and equivalent arrangements. In addition, while the various combinations and configurations, which are preferred, other combinations and configurations, including more, less or only a single element, are also within the spirit and scope of the disclosure.

1. An in-vehicle communication system comprising:
an in-vehicle communication apparatus equipped to a vehicle;
a first mobile communication terminal connected in a communicable manner with the in-vehicle communication apparatus; and
a second mobile communication terminal connected in a communicable manner with the first mobile communication terminal,
wherein each of the in-vehicle communication apparatus, the first mobile communication terminal, and the second mobile communication terminal has a cooperative application program for executing a plurality of contents cooperatively with one another,
wherein each of the plurality of contents includes an application program and a plurality of data required for providing a user with functions corresponding to the content,
wherein the first mobile communication terminal includes:
a content execution unit executing an application program of a predetermined content to process a plurality of data of the predetermined content based on an external operation, the predetermined content being one of the plurality of contents;
a transmission unit transmitting an execution result of the application program of the predetermined content to at least one of the in-vehicle communication apparatus or the second mobile communication terminal; and
a terminal-side forbidding unit, when connected in a communicable manner with the in-vehicle communication apparatus, forbidding an operational input with respect to the predetermined content on the first mobile communication terminal and a screen output of the predetermined content on the first mobile communication terminal,
wherein the in-vehicle communication apparatus includes:
a travel determination unit determining whether or not the vehicle is running; and
an apparatus-side forbidding unit, when the travel determination unit determines that the vehicle is running, forbidding at least one of an operational input with respect to the predetermined content on the in-vehicle communication apparatus or a screen output of the predetermined content on the in-vehicle communication apparatus, and
wherein the second mobile communication terminal includes:
a providing unit enabling at least one of an operational input with respect to the predetermined content on the second mobile communication terminal or a screen output of the predetermined content on the second mobile communication terminal.

2. The in-vehicle communication system according to claim 1,
wherein the operational input with respect to the predetermined content on the first mobile communication terminal refers to an input operation performed by the user on the first mobile communication terminal with respect to the predetermined content, and the screen output of the predetermined content on the first mobile communication terminal refers to a display of the execution result of the application program of the predetermined content on a screen of the first mobile communication terminal,
wherein the operational input with respect to the predetermined content on the in-vehicle communication apparatus refers to an input operation performed by the user on the in-vehicle communication apparatus with respect to the predetermined content, and the screen output of the predetermined content on the in-vehicle communication apparatus refers to a display of the execution result of the application program of the predetermined content on a screen of the in-vehicle communication apparatus, and
wherein the operational input with respect to the predetermined content on the second mobile communication terminal refers to an input operation performed by the user on the second mobile communication terminal with respect to the predetermined content, and the screen output of the predetermined content on the second mobile communication terminal refers to a display of the execution result of the application program of the predetermined content on a screen of the second mobile communication terminal.

3. The in-vehicle communication system according to claim 1,
wherein the terminal-side forbidding unit forbids the operational input with respect to each of the plurality of contents on the first mobile communication terminal and forbids the screen output of each of the plurality of contents on the first mobile communication terminal.

4. The in-vehicle communication system according to any one of claims 1,
wherein the plurality of contents further include at least one different predetermined content, and
wherein the apparatus-side forbidding unit forbids at least one of an operational input with respect to the at least one different predetermined content on the in-vehicle communication apparatus or a screen output of the at least one different predetermined content on the in-vehicle communication apparatus.

5. The in-vehicle communication system according to any one of claims 1,
wherein the first mobile communication terminal is possessed by a driver of the vehicle, and
wherein the second mobile communication terminal is possessed by the user other than the driver of the vehicle.

6-7. (canceled)

8. A mobile communication terminal, when a different mobile communication terminal is not connected in a communicable manner with an in-vehicle communication apparatus equipped to a vehicle, being connected in a communicable manner with the in-vehicle communication apparatus as a main mobile communication terminal, the mobile communication terminal having a cooperative application program for executing a plurality of contents cooperatively with the in-vehicle communication apparatus, each of the plurality of contents including an application program and a plurality of data required for providing a user with functions corresponding to the content,
the mobile communication terminal comprising:
a content execution unit executing an application program of a predetermined content to process a plurality of data of the predetermined content based on an external operation, the predetermined content being one of the plurality of contents;
a transmission unit, when the different mobile communication terminal is connected as a sub mobile communication terminal in a communicable manner with the main mobile communication terminal, transmitting an execution result of the application program of the predetermined content to at least one of the in-vehicle communication apparatus or the sub mobile communication terminal; and
a terminal-side forbidding unit forbidding an operational input with respect to the predetermined content on the main mobile communication terminal and forbidding a screen output of the predetermined content on the main mobile communication terminal.

9. The mobile communication terminal according to claim 8,
wherein the operational input with respect to the predetermined content on the main mobile communication terminal refers to an input operation performed by the user on the main mobile communication terminal with respect to the predetermined content, and the screen output of the predetermined content on the main mobile communication terminal refers to a display of the execution result of the application program of the predetermined content on a screen of the main mobile communication terminal.

10. A mobile communication terminal, when a different mobile communication terminal is connected in a communicable manner with an in-vehicle communication apparatus equipped to a vehicle as a main mobile communication terminal, being connected in a communicable manner with the main mobile communication terminal as a sub mobile communication terminal, the mobile communication terminal having a cooperative application program for executing a plurality of contents cooperatively with the in-vehicle communication apparatus, each of the plurality of contents including an application program and a plurality of data required for providing a user with functions corresponding to the content,
the mobile communication terminal comprising:
a providing unit enabling at least one of an operational input with respect to a predetermined content on the sub mobile communication terminal or a screen output of the predetermined content on the sub mobile communication terminal, the predetermined content being one of the plurality of contents,
wherein the in-vehicle communication apparatus forbids at least one of the operational input with respect to the predetermined content on the in-vehicle communication apparatus or the screen output of the predetermined content on the in-vehicle communication apparatus.

11. The mobile communication terminal according to claim 10,
wherein the operational input with respect to the predetermined content on the sub mobile communication terminal refers to an input operation performed by the user on the sub mobile communication terminal with respect to the predetermined content, and the screen output of the predetermined content on the sub mobile communication terminal refers to a display of an execution result of an application program of the predetermined content on a screen of the sub mobile communication terminal, and
wherein the operational input with respect to the predetermined content on the in-vehicle communication apparatus refers to an input operation performed by the user on the in-vehicle communication apparatus with respect to the predetermined content, and the screen output of the predetermined content on the in-vehicle communication apparatus refers to a display of the execution result of the application program of the predetermined content on a screen of the in-vehicle communication apparatus.
